(19) United States
(12) Patent Application Publication
(10) Pub. No.: US 2011/0044688 A1
(43) Pub. Date: Feb. 24, 2011

(54) REMOTELY OPTICALLY AMPLIFIED PON SYSTEM, OLT, AND RN, AND OPTICAL AMPLIFICATION AND GAIN-CLAMPING METHODS OF PON SYSTEM

(75) Inventors: Han-Hyub LEE, Daejeon-si (KR); Sang-Soo LEE, Daejeon-si (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejeon-si (KR)

(21) Appl. No.: 12/829,910

(22) Filed: Jul. 2, 2010

(30) Foreign Application Priority Data
Aug. 18, 2009 (KR) 10-2009-0076414

(51) Int. Cl. H04B 10/20; H04J 14/00; H01S 3/067; H01S 3/30

(52) U.S. Cl. 398/58; 398/66; 359/341.3; 359/334; 359/337.1

(57) ABSTRACT

A remotely optically amplified passive optical network (PON) system, an optical line terminal, and a remote node, and an optical amplification and gain-clamping methods of the PON system are provided. The PON system generates pump light and transmits the generated pump light to an optical transmission line, amplifies primarily an optical signal by the pump light which pumps the optical transmission line, and amplifies secondarily the optical signal by the transmitted pump light which pumps a gain medium of a remote node while maintaining a gain of the optical signal by applying a gain-clamping method to the remote node.

### CROSS REFERENCE TO RELATED APPLICATION

This application claims the benefit under 35 U.S.C. §119(a) of Korean Patent Application No. 10-2009-0076414, filed on Aug. 18, 2009, the entire disclosure of which is incorporated herein by reference for all purposes.

### BACKGROUND

1. Field

The following description relates to a passive optical network (PON) system, and more particularly, to technology for optical amplification and clamping a signal gain of a passive optical network system which is remotely optically amplified.

2. Description of the Related Art

A passive optical network (PON) consists of an optical line terminal (OLT), a remote node (RN), and at least one optical network unit (ONU). The PON generally connects subscribers to a central office in a local area. In a remote area where subscribers are located far from a central office, transmission distance of the PON increases, and the optical path loss between the central office and each subscriber increases with increase of the number of channels in the PON.

In the remote area, the PON may use an optical amplifier to compensate for optical signal transmission loss since signal transmission may not be possible due to performance limitation of an optical transceiver. However, in the PON, an RN is designed to not consume any power, and thus it is not easy to utilize an independent optical amplifier in the RN, wherein the independent optical amplifier uses an active optical element that requires a driving power.

In the case of an independent optical amplifier, a power plant should be added to the RN since the independent optical amplifier is supplied with power from the RN itself, and additional costs may be incurred to maintain and manage the optical amplifier stably. Therefore, a PON technology that is capable of amplifying an optical signal for increasing transmission distance without requiring power in an RN is needed.

In the meantime, the amplitude of an optical signal transmitted from an OLT may be increased to compensate for the optical path loss. However, a higher specification of the OLT is required for optical transmission, and thus its price is raised. Moreover, a part of an optical signal incident to the optical transmission line is reflected and propagates back, and then is input to the optical receiver of the OLT, so that signal transmission quality can be reduced. Hence, it is not easy to increase the amplitude of the optical signal.

### SUMMARY

In one general aspect, there is provided a passive optical network (PON) system which increases transmission distance of an optical signal or expands the number of channels by amplifying the optical signal transmitted to an optical line terminal (OLT) without requiring power in a remote node, and an optical amplification method of the PON system.

Furthermore, there is provided a remotely optically amplified PON system which provides a flat signal gain which is constant with respect to wavelength even when the amplitude of an optical signal or the number of operative channels is changed during optical signal amplification.

According to one general aspect, there is provided a passive optical network including: an optical line terminal to generate pump light and transmit the generated pump light to an optical transmission line and to primarily amplify an optical signal by pumping the optical transmission line using the pump light; and a remote node to include a gain medium which is pumped by the transmitted pump light and consequently amplifies the optical signal secondarily and to maintain constant population inversion of the gain medium to clamp a signal gain.

According to another general aspect, there is provided an optical transmission terminal comprising: a pump light source transmitting unit to transmit pump light to an optical transmission line such that the pump light remotely pumps a gain medium of a remote node and thus amplifies secondarily an optical signal which has been amplified primarily in the optical transmission line.

According to still another general aspect, there is provided a remote node comprising: an optical amplifier to amplify an optical signal by pumping a gain medium using pump light received through an optical transmission line; a gain clamping unit to clamping a signal gain by maintaining constant population inversion of the gain medium during the optical signal is amplified; and an optical dividing/coupling unit to split or combine the optical signal.

According to yet another general aspect, there is provided an optical amplification method of an optical transmission terminal, the method comprising: generating pump light; primarily amplifying an optical signal by pumping an optical transmission line using the pump light; transmitting the pump light to the optical transmission line; and secondarily amplifying the optical signal by enabling the transmitted pump light to remotely pump a gain medium of a remote node.

According to another general aspect, there is provided a gain clamping method of a remote node, the method comprising: pumping a gain medium using pump light transmitted through an optical transmission line; amplifying an optical signal through population inversion of the gain medium during the pumping; and clamping a signal gain of the gain medium by maintaining the population inversion to be constant.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 illustrates an example of a passive optical network (PON) system.

FIG. 2 illustrates an example of an optical line terminal (OLT).

FIG. 3 illustrates an example of a remote node (RN).

FIG. 4 illustrates an example of a gain clamping unit of the RN of FIG. 3.

FIG. 5 illustrates another example of a gain clamping unit of the RN of FIG. 3.

FIG. 6 illustrates an example of a gain flattening unit of the RN of FIG. 3.

FIG. 7 is a graph showing change of the amplitude of a downstream optical signal with respect to a transmission distance according to optical amplification.

FIG. 8 is a graph showing a relationship between the amplitude of an input signal and a signal gain according to the presence of the gain clamping unit of FIG. 3.

FIG. 9 illustrates a flowchart of an example of an optical amplification method.

FIG. 10 illustrates a flowchart of an example of a gain clamping method.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

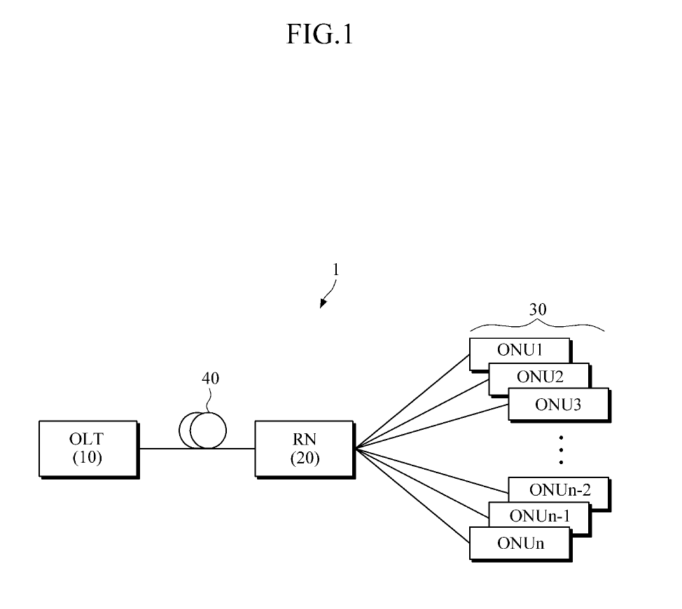

FIG. 1 illustrates an example of a passive optical network (PON) system 1. Referring to FIG. 1, the PON system 1 includes an optical line terminal (OLT) 10, a remote node (RN) 20, one or more optical network units (ONUs) 30, and an optical transmission line 40.

In the PON system 1, the OLT 10 transmits a downstream optical signal to the RN 20, and the RN 20 transmits the downstream optical signal received from the OLT 10 to each ONU 30. In the same manner, upstream optical signals generated by ONUs 30 are multiplexed in the RN 20 and then transmitted to the OLT 10.

In one example, the OLT 10 provides pump light to the optical transmission line 40. Then, the optical transmission line 40 which functions as a gain medium is pumped with the pump light, resulting in Raman amplification of the optical signal. That is, the optical signal is primarily amplified. The pump light transmitted to the optical transmission line 40 pumps a gain medium located at the RN 20 to secondarily amplify the optical signal amplified through Raman amplification.

As such, since the optical signal is amplified without requiring power in the RN 20, optical signal transmission distance of the PON system 10 can be more effectively increased. Furthermore, the optical signal is amplified twice, so that the pump light use efficiency on the optical transmission line 40 and the RN 20 can be maximized.

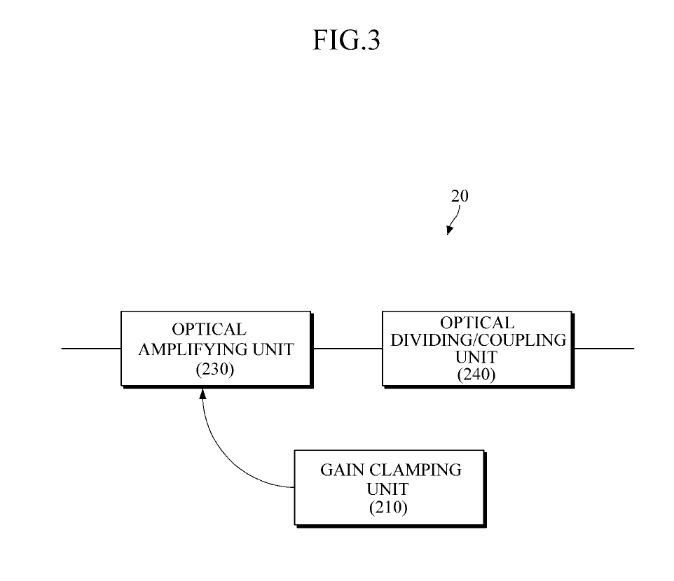

The RN 20 clamps the signal gain by maintaining constant population inversion of the gain medium during the secondary amplification. The gain medium may be an erbium-doped fiber (EDF). The RN 20 may use a ring-shaped laser resonator or a linear laser resonator to generate the clamped signal gain. Detailed description of clamping of a gain by the RN 20 will be provided later with reference to FIGS. 3 to 5.

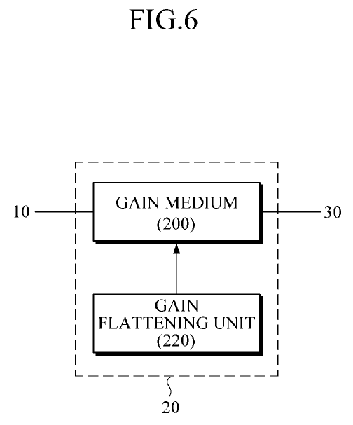

The RN 20 may flatten the signal gain which varies with the wavelength of light. In this case, even when the amplitude of an optical signal transmitted through the optical transmission line 40 during the optical signal amplification is changed or the number of operative channels is changed, the RN 20 can provide a flat signal gain constant with respect to wavelength of a signal by clamping and flattening the signal gain regardless of the changes. Detailed description of flattening of the signal gain by the RN 20 will be provided later with reference to FIG. 6.

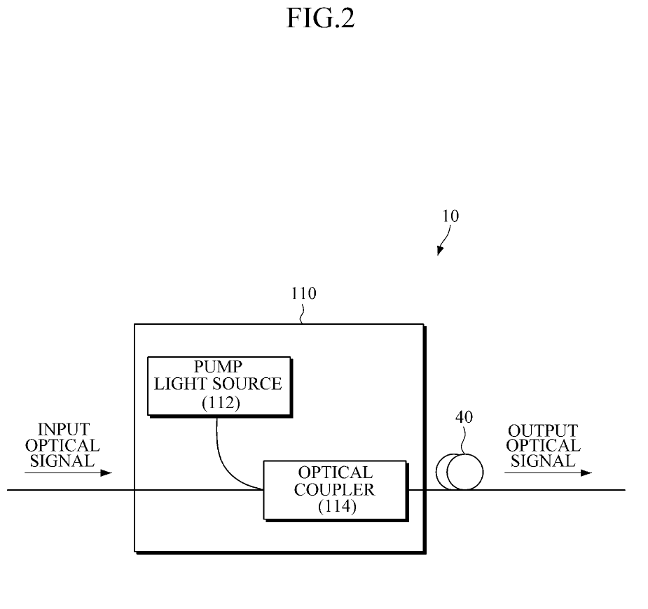

FIG. 2 illustrates an example of an optical line terminal (OLT) 10. Referring to FIG. 2, the OLT 10 includes a pump light source transmitting unit 110, which includes a pump light source 112 and an optical coupler 114.

The pump light source 112 generates pump light. The pump light source 112 may be implemented as a semiconductor laser diode or an optical fiber laser, and the applicable types of pump light source are not limited thereto. An optical transmission line 40 is amplified by the generated pump light, and thus an optical signal is primarily amplified. The pump light source transmitting unit 110 employs a distributed amplification scheme in which the optical transmission line 40 is optically directly amplified using pump light and thus distributed Raman gain is obtained. The distributed Raman gain arises from Raman scattering which occurs in the optical transmission line 40 due to pump light. The Raman scattering is a phenomenon occurring when pump light transmitted through the optical transmission line 40 that is a gain medium is scattered with less energy than the original energy. That is, scattered light is generated at wavelength longer than the wavelength of the pump light and an optical signal having the same wavelength as that of the scattered light is transmitted. Then, the energy of the scattered light is transferred to the optical signal, thereby enabling optical amplification of the optical signal. In this case, since the optical transmission line 40 is employed as a gain medium, an additional gain medium is not required.

The optical coupler 114 multiplexes the pump light output from the pump light source 112, and transmits the multiplexed pump light to the optical transmission line 40. The pump light transmitted to the optical transmission line 40 has its amplitude reduced in proportion to an optical loss of an optical fiber. Then, the pump light with its amplitude reduced is transmitted to the RN 20 to pump a gain medium of the RN 20, thereby secondarily amplifying the Raman amplified optical signal. The gain medium of the RN 20 may be an erbium-doped fiber (EDF).

In one example, the pump light source transmitting unit 110 transmits the pump light downstream toward the optical transmission line 40, and applies distributed Raman gain to the optical signal transmitted downstream to the RN 20 using the Raman scattering occurring in the optical transmission line 40 due to the pump light. Moreover, when the gain medium of the RN 20 is pumped with the downstream transmitted pump light, an additional gain is applied to the optical signal which has been applied with the distributed Raman gain. A wavelength of the pump light may be determined in consideration of a Raman gain band of an optical signal. For example, to obtain Raman gain at 1550 nm, the pump light source 112 may generate pump light having a wavelength band of 1450 nm.

FIG. 3 illustrates an example of an RN 20. Referring to FIG. 3, the RN 20 includes an optical amplifying unit 230, an optical dividing/coupling unit 240, and a gain clamping unit 210.

The optical amplifying unit 230 pumps a gain medium to amplify an optical signal using pump light received through an optical transmission line 40. At this time, population inversion of the gain medium occurs due to the pump light, resulting in amplification of the optical signal. The pump light pumps the optical transmission line 40, which is a gain medium in an optical line terminal (OLT), thereby primarily amplifying the optical signal, and is simultaneously transmitted to the optical transmission line 40 to pump the gain medium of the RN 20, thereby secondarily amplifying the optical signal. The gain medium of the RN 20 may be an EDF.

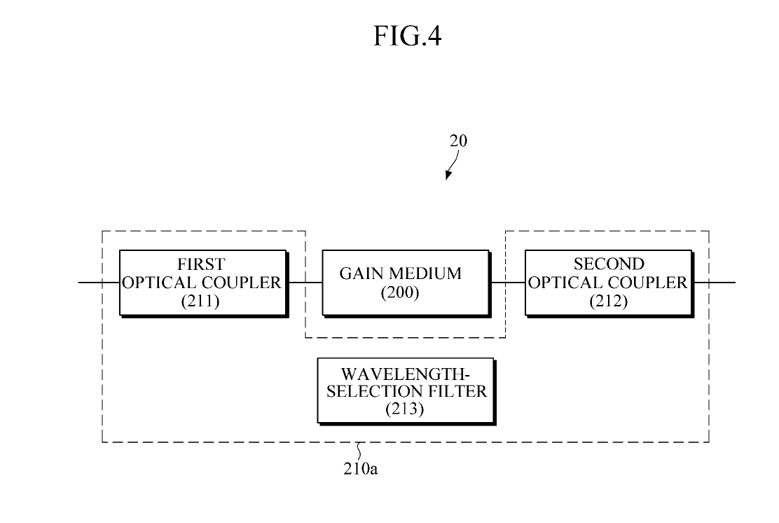

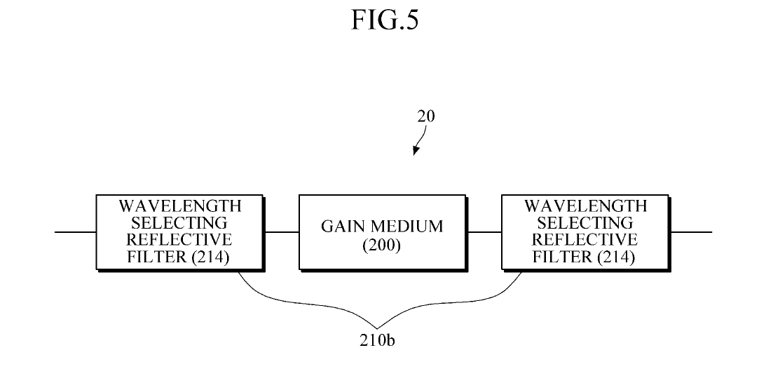

The gain clamping unit 210 maintains the constant population inversion of the gain medium to clamp a signal gain. The gain clamping unit 210 may be implemented as a ring laser resonator, which will be described later with reference with FIG. 4, or a linear laser resonator, which will be described later with reference with FIG. 5. When the gain clamping unit 210 clamps the signal gain, a constant signal gain can be provided during optical signal amplification even when the amplitude of an optical signal transmitted through the optical transmission line or the number of operative channels is changed.

The optical dividing/coupling unit 240 splits or combines upstream/downstream optical signals. In detail, the optical dividing/coupling unit 240 splits one incoming optical signal into multiple outbound optical signals, or combines multiple incoming optical signals into one output signal.

FIG. 4 illustrates an example of a gain clamping unit 210a of the RN 20 of FIG. 3. Referring to FIG. 4, the gain clamping unit 210a includes a first optical coupler 211, a wavelength selection filter 213, and a second optical filter 212.

As shown in FIG. 4, the first optical filter connected to one end of the wavelength selection filter 213 transmits spontaneous emission light generated by a gain medium 200 to the wavelength selection filter 213. Then, the wavelength selection filter 213 selects light having a specific wavelength from the received spontaneous emission light. The second optical coupler 212 connected to the other end of the wavelength selection filter 213 transmits the light selected by the wavelength selection filter 213 to the gain medium 200.

In this example, a ring-shaped laser resonator is employed in which the first optical coupler 211, the wavelength selection filter 213 and the second optical coupler 212 are arranged in a ring-shaped manner around the gain medium 200 and the light having the wavelength finally selected by the wavelength selection filter 213 oscillates as laser light. The laser light is a gain-clamping signal which maintains the population inversion of the gain medium 200 to be constant. That is, the light having the finally selected wavelength oscillates as laser light, and when the laser oscillates, the population inversion of the resonator is maintained constant, and accordingly the signal gain is also maintained constant, enabling the laser light to function as the gain-clamping signal.

In another example, the gain clamping unit 210a may further include an optical attenuator (not shown). Since the above-described gain-clamping laser light oscillates when the loss and the gain of the resonator are equal to each other, the optical attenuator may adjust the loss of the resonator to maintain a desired gain.

In addition, the gain clamping unit 210a may further include pump-light couplers (not shown). The pump-light couplers may be located at both ends of the first optical coupler 211, and bypass transmitted pump light, thereby preventing the occurrence of the pump light loss. That is, the pump light couplers bypass the pump light at the both ends of the first optical coupler 211 because the pump light loss may occur in the first optical coupler 211.

FIG. 5 illustrates another example of a gain clamping unit 210b of the RN 10 of FIG. 3. Referring to FIG. 5, the gain clamping unit 210b includes wavelength selecting reflective filters 214 at both ends of a gain medium 200.

One of the wavelength selecting reflective filters 214 receives spontaneous emission light generated from the gain medium 200 and the other wavelength selecting reflective filter 214 transmits it to the gain medium 200 again to select light having a specific wavelength from the spontaneous emission light. In the example, the gain medium 200 and the wavelength selecting reflective filters 214 are implemented as a linear laser resonator that oscillates the light having the wavelength finally selected by the wavelength selecting reflective filters 214 as laser light. The laser light is a gain-clamping signal that maintains the population inversion of the resonator to be constant. In this case, a signal gain can be controlled during amplification by adjusting light reflection rate of the wavelength selecting reflective filters 214.

FIG. 6 illustrates an example of a gain flattening unit 220 of the RN 20 of FIG. 3.

Generally, since a gain difference between wavelengths occurs during optical amplification, the output amplitude of channels may not be uniform according to the wavelengths and amplitude of the respective channels input to an optical amplifier. In one example, the RN 20 has the gain flattening unit 220 connected to an end of the gain medium 200 to control a signal gain to be flat. The gain flattening unit 220 may be configured as a thin layer filter or an optical fiber brag grating of which wavelengths have different loss values, but the type of the gain flattering unit 220 is not limited thereto.

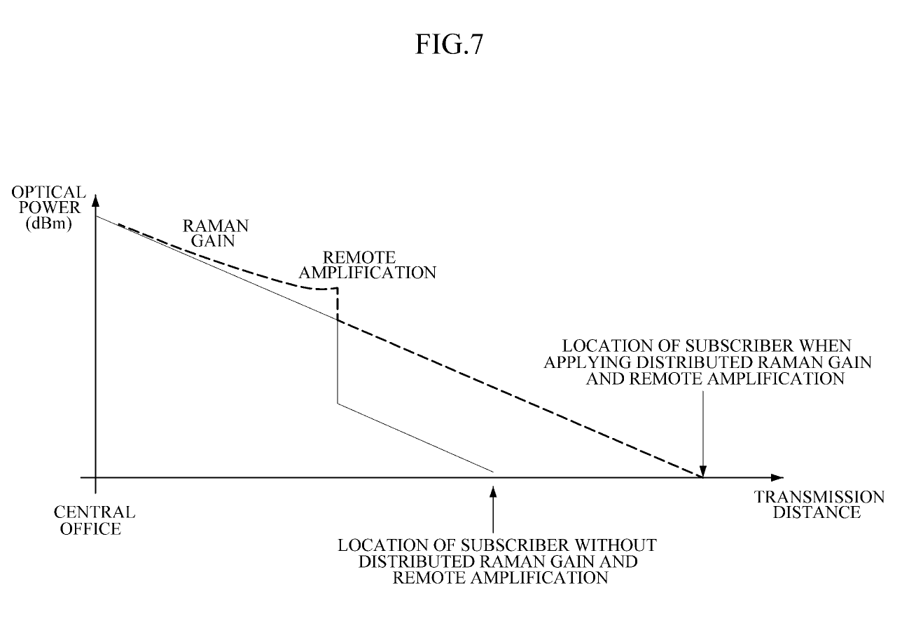

FIG. 7 is a graph showing change of the amplitude of a downstream optical signal with respect to a transmission distance according to optical amplification. In FIG. 7, the amplitude of the downstream optical signal and the location where a subscriber can be placed with respect to the transmission distance are compared between a general PON system and a PON system in which amplification using distributed Raman gain and remote amplification take place. The amplitude of the optical signal of the general PON system is represented by a solid line, and the amplitude of the optical signal of the PON system where the amplification due to the Raman gain and the remote amplification occur is represented by a dotted line.

The downstream optical signal of the general PON system has its amplitude reduced with time due to transmission optical fiber loss, and in an RN, the amplitude of the optical signal is reduced due to the signal distribution loss. However, according to an exemplary embodiment, the PON system with the distributed Raman gain and the remote amplification, the downstream optical signal obtains the distributed Raman gain in the optical transmission line, and obtains an additional gain in an RN, thereby enabling to transmit the optical signal further. Accordingly, the transmission distance of the PON system can be effectively increased without requiring power in the RN, and thus the PON system according to the exemplary embodiment is substantially suitable for long-distance transmission.

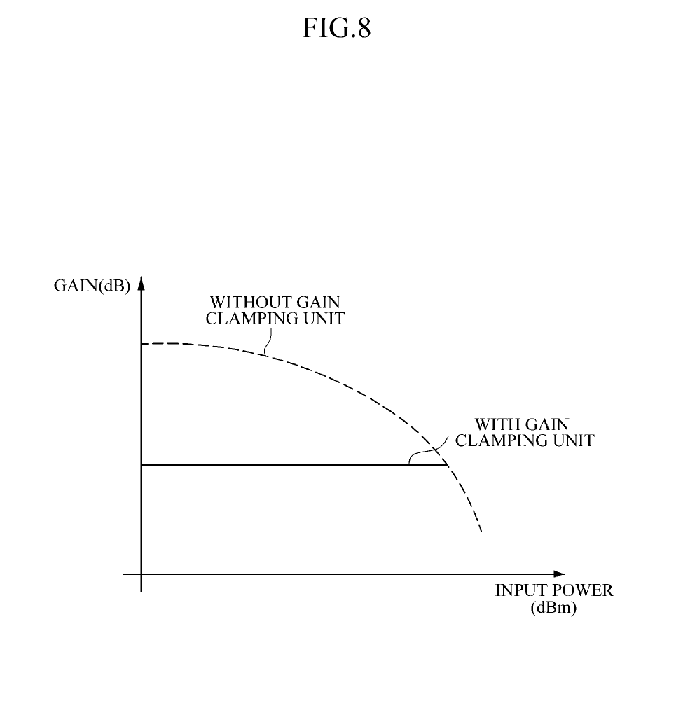

FIG. 8 is a graph showing a relationship between the amplitude of an input signal and a signal gain according to the presence of the gain clamping unit 210 of FIG. 3. Referring to FIG. 8, in an optical amplifier without the gain clamping unit 210, as the amplitude of the input signal is increased, a gain is reduced, and as the amplitude of the input signal is reduced, the gain is increased. Thus, when the number of channels operated by the PON system is changed (that is, the amplitude of all signals input to the optical amplifier is changed), a signal gain is also changed. However, an optical amplifier with the gain clamping unit 210 can provide a constant gain, and hence a signal gain can be clamped to a predetermined level even when the number of signal channels is changed.

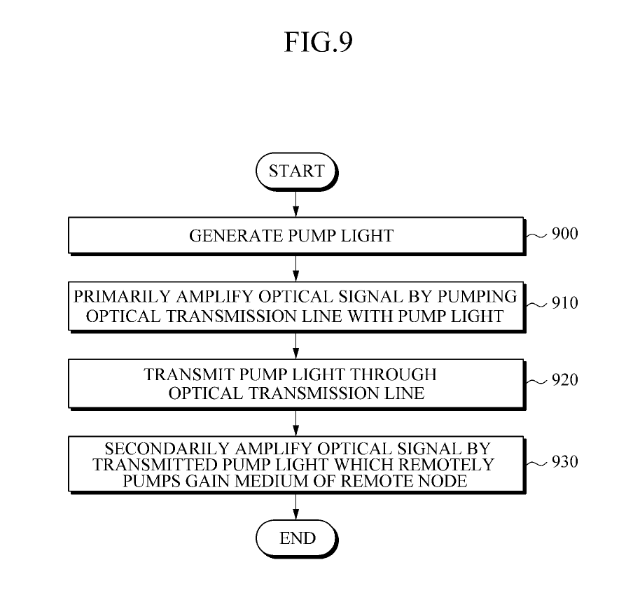

FIG. 9 illustrates a flowchart of an example of an optical amplification method. Referring to FIG. 9, an OLT generates pump light using a pump light source at 900. Then, the OLT pumps an optical transmission line using the pump light to amplify primarily an optical signal at 910. At this time, the OLT uses Raman scattering, which occurs in the optical transmission line due to the pump light, to provide distributed Raman gain to the optical signal to be transmitted downstream to an RN.

Subsequently, the OLT transmits the pump light to the optical transmission line at 920. The transmitted pump light remotely pumps a gain medium of the RN to secondarily amplify the optical signal at 930. At this time, an additional gain may be provided to the optical signal to which the distributed Raman gain has been applied.

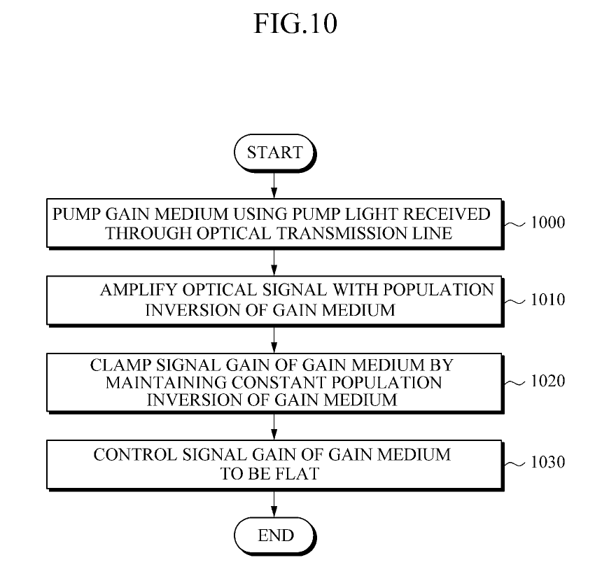

FIG. 10 illustrates a flowchart of an example of a gain clamping method. Referring to FIG. 10, a gain medium of an RN is pumped by pump light transmitted through an optical transmission line at 1000. The RN amplifies an optical signal through population inversion of the gain medium which occurs during the pumping at 1010. Then, the RN maintains the constant population inversion to clamp a signal gain of the gain medium at 1020. Furthermore, at 1030, the RN controls a signal gain of the gain medium to be constant, where the signal gain varies with the wavelength of the light.

As described above, an optical signal can be amplified without requiring power in RN, and thus optical signal transmission distance of a PON system can be effectively increased.

In addition, primary and secondary amplifications of an optical signal are performed, so that pump light use efficiency can be maximized on an optical transmission line and the RN. Moreover, a signal gain can be increased more than a predetermined level.

Furthermore, even when the amplitude of an optical signal transmitted through the optical transmission line or the number of operative channels is changed during optical signal amplification, a flat signal gain which is constant with respect to wavelength can be provided by clamping and flattening a signal gain.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A passive optical network comprising:
an optical line terminal to generate pump light and transmit the generated pump light to an optical transmission line and to primarily amplify an optical signal by pumping the optical transmission line using the pump light; and
a remote node to include a gain medium which is pumped by the transmitted pump light and consequently amplifies the optical signal secondarily and to maintain population inversion of the gain medium to clamp a signal gain

2. The passive optical network of claim 1, wherein the optical line terminal provides a distributed Raman gain to an optical signal transmitted downstream to the remote node using Raman scattering in the optical transmission line, which occurs in the optical transmission line due to the pump light, and applies an additional gain to the optical signal, which has been provided with the distributed Raman gain, by transmitting the pump light downstream to the optical transmission line and thereby enabling the pump light to pump the gain medium of the remote node.

3. The passive optical network of claim 1, wherein the remote node maintains the constant population inversion of the gain medium by use of a laser resonator.

4. The passive optical network of claim 1, wherein the gain medium of the remote node is an erbium-doped fiber.

5. An optical transmission terminal comprising:
a pump light source transmitting unit to transmit pump light to an optical transmission line such that the pump light remotely pumps a gain medium of a remote node and thus amplifies secondarily an optical signal which has been amplified primarily in the optical transmission line.

6. The optical transmission terminal of claim 5, wherein the pump light transmitting unit includes a pump light source to generate the pump light and an optical coupler to multiplexes the pump light on the optical transmission line.

7. The optical transmission terminal of claim 5, wherein the pump light source transmitting unit applies an additional gain to an optical signal, which has been provided with distributed Raman gain, by transmitting the pump light downstream to the optical transmission line and thereby enabling the pump light to pump the gain medium of the remote node.

8. A remote node comprising:
an optical amplifier to amplify an optical signal by pumping a gain medium using pump light received through an optical transmission line;
a gain clamping unit to clamping a signal gain by maintaining constant population inversion of the gain medium during the optical signal is amplified; and
an optical dividing/coupling unit to split or combine the optical signal.

9. The remote node of claim 8, wherein the pump light is signal light that pumps the optical transmission line to primarily amplify the optical signal and pumps the gain medium to secondarily amplify the optical signal when the optical signal is transmitted through the optical transmission line.

10. The remote node of claim 8, wherein the gain clamping unit includes a first optical coupler which is connected to an end of a wavelength selection filter and transmits spontaneous emission light generated by the gain medium to the wavelength selection filter, the wavelength selection filter which selects a specific wavelength from the spontaneous emission light, and a second optical coupler which is connected to the other end of the wavelength selection filter and transmits light having the selected wavelength to the gain medium.

11. The remote node of claim 10, wherein the first optical coupler, the wavelength selection filter and the second optical coupler form a ring-shaped laser resonator which oscillates the light having the selected wavelength as laser light and the laser light is a gain-clamping signal that maintains the constant population inversion of the gain medium.

12. The remote node of claim 10, wherein the gain clamping unit further includes pump optical couplers which are located at both ends of the first optical coupler and bypass the transmitted pump light to prevent pump light loss.

13. The remote node of claim 8, wherein the gain clamping unit further includes wavelength selecting reflective filters which are connected to both ends of the gain medium and by receiving the spontaneous emission light generated by the gain medium and transmitting the spontaneous emission light to the gain medium again.

14. The remote node of claim 13, wherein the gain medium and the wavelength selecting reflective filters form a linear laser resonator which oscillates the light having the wavelength finally selected by the wavelength selecting reflective filters as laser light and the laser light is a gain-clamping signal that maintains the constant population inversion of the gain medium.

15. The remote node of claim 8, further comprising:
a gain flattening unit to be connected to an end of the gain medium and flatten a signal gain which varies with wavelength of the optical signal.

16. An optical amplification method of an optical transmission terminal, the method comprising:
generating pump light;
primarily amplifying an optical signal by pumping an optical transmission line using the pump light;
transmitting the pump light to the optical transmission line; and
secondarily amplifying the optical signal by enabling the transmitted pump light to remotely pump a gain medium of a remote node.

17. The method of claim 16, wherein the primary amplifying of the optical signal includes providing distributed Raman gain to the optical signal transmitted downstream to the remote node using Raman scattering generated on the optical transmission line due to the pump light and the secondary amplifying of the optical signal includes assigning an additional gain to the optical signal which has been provided with the distributed Raman gain by enabling the pump light which is transmitted downstream to the optical transmission line to pump the gain medium of the remote node.

18. A gain clamping method of a remote node, the method comprising:
pumping a gain medium using pump light transmitted through an optical transmission line;
amplifying an optical signal through population inversion of the gain medium during the pumping; and
clamping a signal gain of the gain medium by maintaining the population inversion to be constant.

19. The method of claim 18, wherein the pump light is signal light that pumps the optical transmission line to primarily amplify the optical signal and pumps the gain medium to secondarily amplify the optical signal when the optical signal is transmitted through the optical transmission line.

20. The method of claim 18, further comprising:
flattening a signal gain of the gain medium which varies with wavelength of the optical signal.
